(19) United States
(12) Patent Application Publication
(10) Pub. No.: US 2012/0281135 A1
(43) Pub. Date: Nov. 8, 2012

(54) Handpiece Camera

(76) Inventors: Herbert Gebhardt, Siegelsbach (DE); Raimund Maier, Tamm (DE); Peter Lais, Erligheim (DE); Martin Duerrstein, Bietigheim-Bissingen (DE); Michael Thoms, Erlangen (DE)

(21) Appl. No.: 13/496,111

(22) PCT Filed: Aug. 26, 2010
(86) PCT No.: PCT/EP2010/005237

§ 371 Date: Jul. 27, 2012

(30) Foreign Application Priority Data
Sep. 14, 2009 (DE) 10 2009 041 151.8

(51) Int. Cl. H04N 5/225

(52) U.S. Cl. 348/374; 348/E05.024

(57) ABSTRACT

A handpiece camera, comprising an illumination device optical elements, and an image converter. A housing is provided with an entrance window, through which an observation light returning from an examination area shines in, which is subsequently conducted to the image converter by the optical elements. The camera has a head part and a handle part, which are detachably connected to one another. The handle part can be adjusted to a wide variety of purposes when combined with different head parts.

Cameras of such a type with an electronic image-converter come into operation, for example, for the purpose of diagnosis at inaccessible places in the human body or in the body of an animal. They also find widespread application in dentistry.

From DE 10 2004 024 494 A1 a camera is known which includes a housing in which an illuminating device and optical elements are arranged. At the top of the housing an entrance window is provided, into which observation light reflected from a test specimen is incident. Optical elements in the head member and handle member of the camera direct the observation light onto an image-converter. The image-converter is connected to camera electronics which make available operating signals and supply signals for the camera and carry out, via an evaluation circuit, an editing of the image, for example with a view to output on a screen.

A disadvantageous aspect of the known cameras is that the components arranged in the housing of the camera are difficult to access, and an exchange is not possible. For various applications a special camera is therefore required in each instance, as a result of which high investment costs arise. Furthermore, in the course of a sterilisation which is indispensable for handpiece cameras the entire instrument has to be sterilised, by virtue of which said instrument is unavailable for some time and on the whole is only permitted to contain sterilisable components.

The object of the invention is, in contrast, to make a handpiece camera available that enables an interchange of individual components.

This object is achieved by means of a camera with the features of claim 1.

The handpiece camera according to the invention includes a housing with a head member which is detachably connected to a handle member. The head member is therefore removable from the handle member and interchangeable. The head member which has been contaminated in the oral space of a patient is capable of being sterilised separately from the handle member, as a result of which the camera continues to be available in conjunction with another head member.

Advantageous further developments of the invention are specified in the dependent claims.

The further development of the camera according to claim 2 enables a demand-satisfying arrangement of an illuminating device on the handle member. Consequently head members with illuminating devices radiating with variable brightness are capable of being fitted to the handle member, for example for intra-oral and extra-oral photographs.

With the further development of the invention according to claims 3 and 4 it is ensured that the handle member is capable of being used for various types of photograph, such as, for example, macrophotographs or wide-angle photographs, by fitting differing head members.

By virtue of an attachment of a head member with a filter, a camera according to claim 5 can be employed for tissue examinations, for example with UV light, in which case said filter passes fluorescent light radiated from the test tissue and filters out the exciting UV light.

The further development of the invention according to claim 6 displays the advantage that the head member comprises few components and is therefore capable of being prepared economically.

A camera according to claim 7 enables a recording of an image in the transverse direction with respect to the handle axis.

The camera according to claim 8 enables a dissipation of heat from the head member. A conductive connection directs to the handle member the heat that arises, for example, by virtue of radiation of the illuminating device. A concentration of the heat and an overheating of components in the head member is therefore avoided. The heat-conducting connection is constructed, for example, in the form of an aluminium bridge. The illuminating device is preferably arranged in an aluminium support which is connected to the handle member via the aluminium bridge or otherwise suitable materials.

A camera according to claim 9 has the advantage that, according to demand, head members with differing illuminating devices are capable of being employed, whereby merely a suitable power supply has to be provided.

A camera according to claim 10 has the advantage that when a head member is being mounted onto the handle member the illuminating device is connected simultaneously to the source of current of the handle member by an appropriate arrangement of the contacts.

The further development of the invention according to claim 11 makes it possible to provide electrical loads and electrical signal-sources on the interchangeable head member and to connect them detachably to leads in the interior of the handle member, whereby the contacts are brought into engagement successively when the head member is being pushed on, so that an easier pushing of the head member onto the handle member is obtained.

In this connection, with the further development of the invention according to claim 12 it is guaranteed that a current flows via the contacts only when all the contacts and mating contacts are facing one another correctly.

The further development of the invention according to claim 13 is also advantageous with regard to a closing and opening of the connection between head member and handle member with small forces, whereby nevertheless there is a reliable electrical connection between the contacts and mating contacts.

With the further development of the invention according to claim 14 an automatic interlocking of the head member onto the handle member is obtained automatically via the contact arrangement.

In this connection the further development of the invention according to claim 15 is advantageous insofar as the ends of the leaf spring exhibit a linear contact with the rounded end portions of the contacts.

A camera according to claim 16 can be used for differing photographs and diagnoses by employing a head member with an appropriate illuminating device.

A camera according to claim 17 includes a head member which, in addition to low production costs, exhibits a compact structure with low weight. At the same time, the heat emission of LEDs is slight.

The camera according to claim 18 autonomously performs a setting, appropriate for each head member, of an optical element and/or an electrical element, whereby such electrical elements may include both actuators and electronic controllers. For example, the position of optical lenses or the stop-number is set automatically via an appropriate servomechanism. An incorrect setting by the user is therefore ruled out.

In the case of a camera according to claim 19, information about the head member is stored in a transponder. A readout device in the handle member ascertains in contact-free manner the data stored in the transponder and transmits them to a control device which performs an adjustment of optical elements and/or electrical elements of the camera.

In the case of a camera according to claim 20, electrical contacts are provided on the handle member and/or head member, whereby in the case of a combination of the handle member with differing head members different contacts close in each instance. The closing of a contact triggers an adjustment of a camera element. The use of contacts that are commercially available as mass-produced articles constitutes an economical way of recognising the type of head member.

In the case of a camera according to claim 21, 22 or 23 a contact-free recognition of various head members is possible. The utilisation of magnetic force enables a direct mechanical adjustment of optical elements. Furthermore, the position of the magnet can also be determined via switching contacts that can be used for driving electrical elements. This type of adjustment is only slightly error-prone and is robust. A reed switch interacting in contact-free manner with the magnet operates in frictionless manner and does not influence the movement of the magnet in the handle member.

In the case of a camera according to claims 24, 25 and 26 the diaphragm is adjusted as a function of the design of the mounted head member. For example, the diaphragm closes by itself in the case of a head member for macrophotographs. A mechanical coupling of the magnet with the diaphragm enables a currentless adjustment. Alternatively, a position of the magnet evaluated by switching contacts can be used for the purpose of driving an electric motor adjusting the diaphragm. The means may, of course, also perform an adjustment of further optical elements, for example an axial displacement of a lens.

In the case of a camera according to claim 27 an autonomous setting of functions of image-recording and evaluation is undertaken as a function of the head member used, i.e. the camera electronics autonomously set, for example, a correct amplification, a white balance, etc. An incorrect operation by the user is therefore ruled out.

In the case of a camera according to claim 28 there is a secure connection between head member and handle member. At the same time, a rapid interchange of the head member is also possible. In this connection a seal, such as an O-ring for example, prevents an ingress of dirt or moisture into the camera.

Embodiments of the invention are represented in the drawings and will be elucidated in more detail in the following description. Shown in the drawings are:

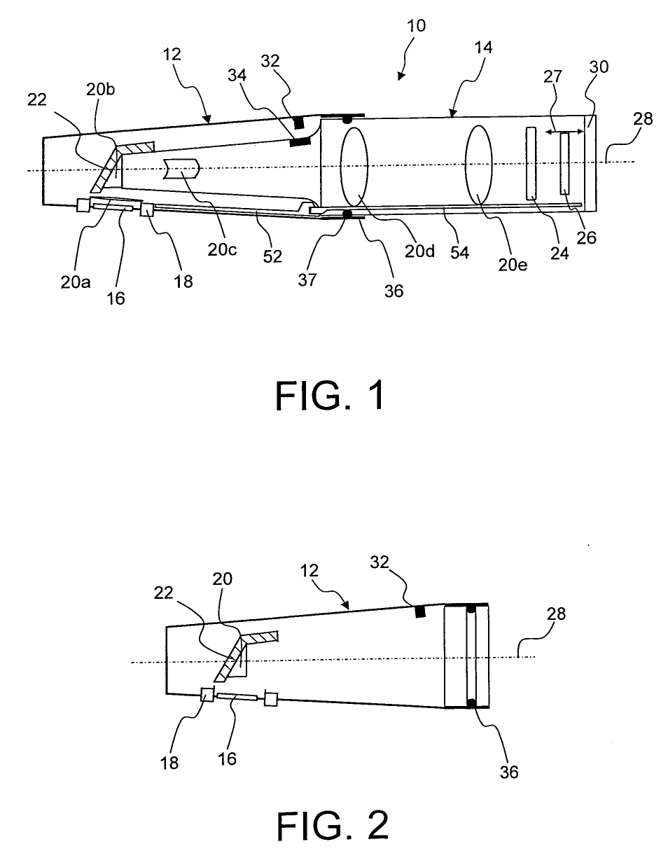

FIG. 1: a schematic sectional view of a dental or medical handpiece camera with a handle member and a head member;

FIG. 2: a variant of the head member from FIG. 1;

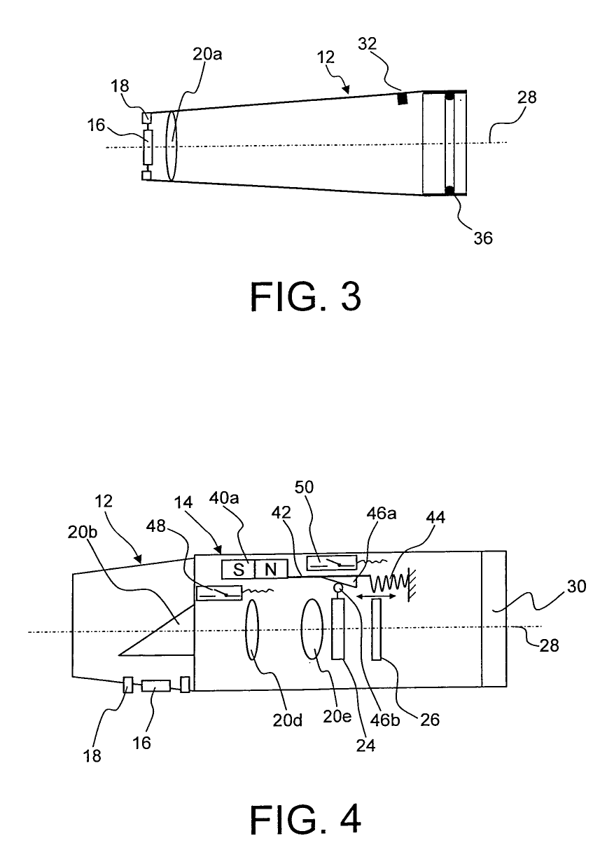

FIG. 3: a further variant of the head member from FIG. 1;

FIG. 4: a camera with an adjusting magnet in neutral position;

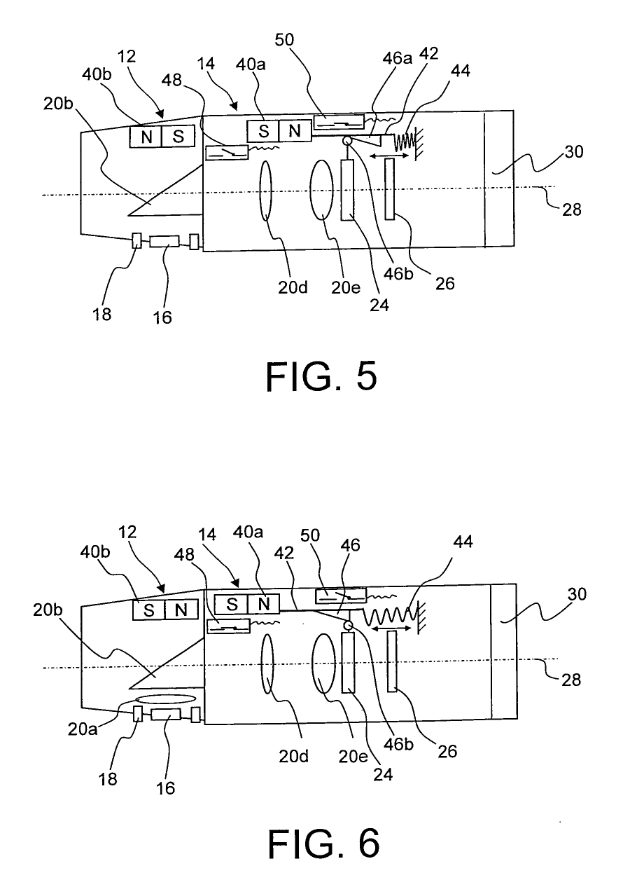

FIG. 5: a camera with the adjusting magnet in a first deflected position;

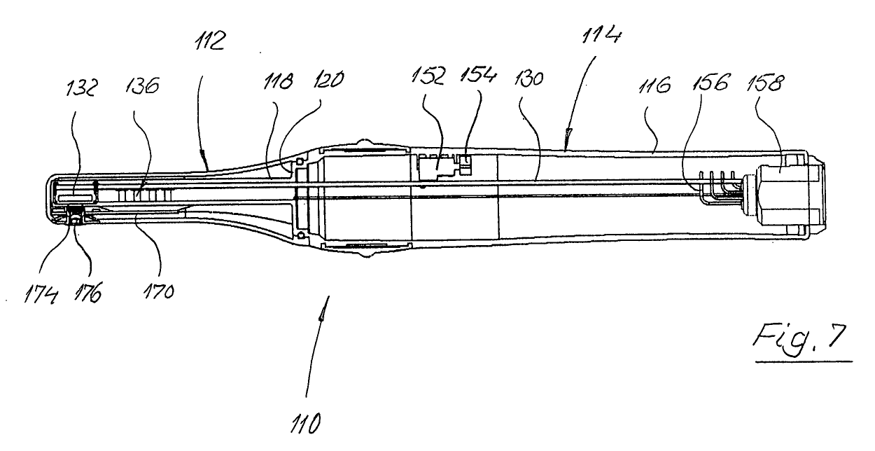

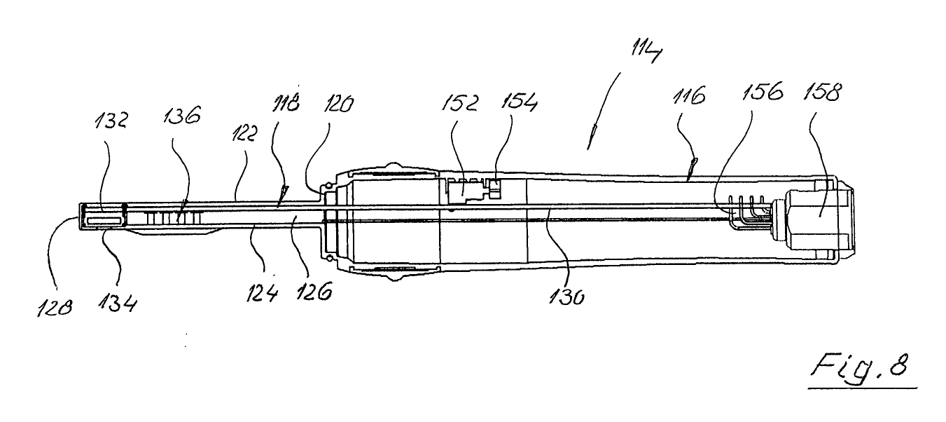

FIG. 6: a camera with the adjusting magnet in a second deflected position;

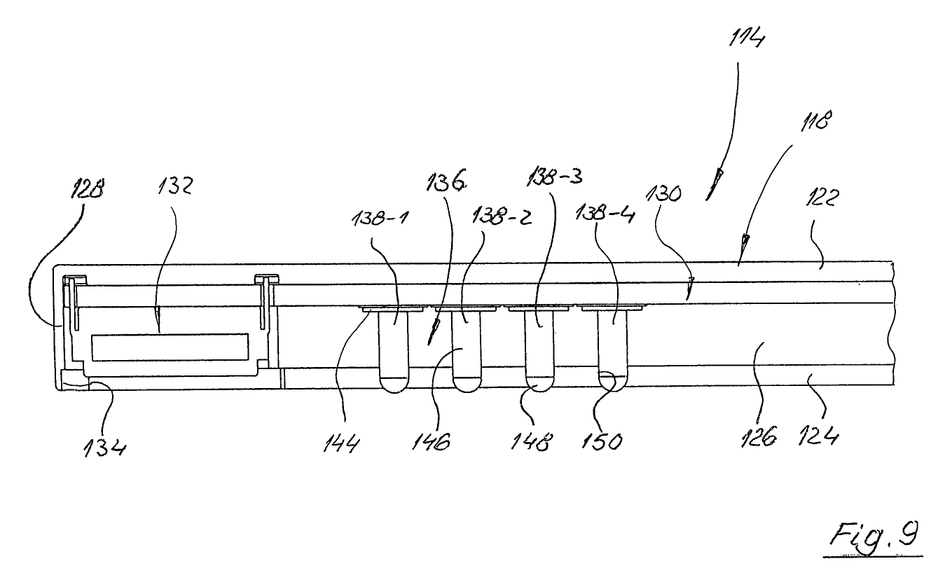

FIG. 7: a longitudinal section through a further embodiment of the invention, wherein the image-converter is provided at the objective-side end of the camera;

FIG. 8: a view similar to FIG. 7, wherein, however, the head member has been removed;

FIG. 9: an enlarged view of the free end portion of the handle member on an enlarged scale;

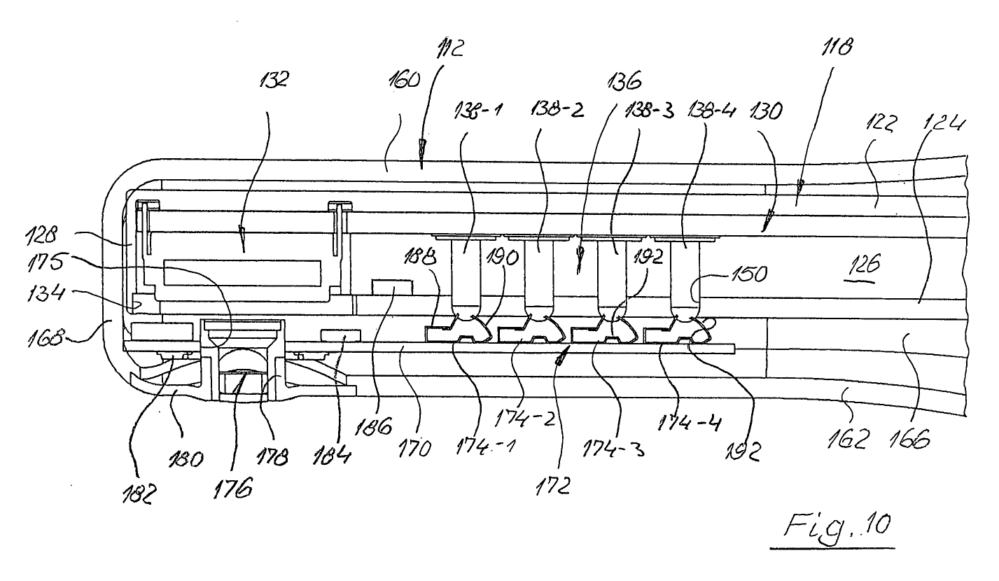

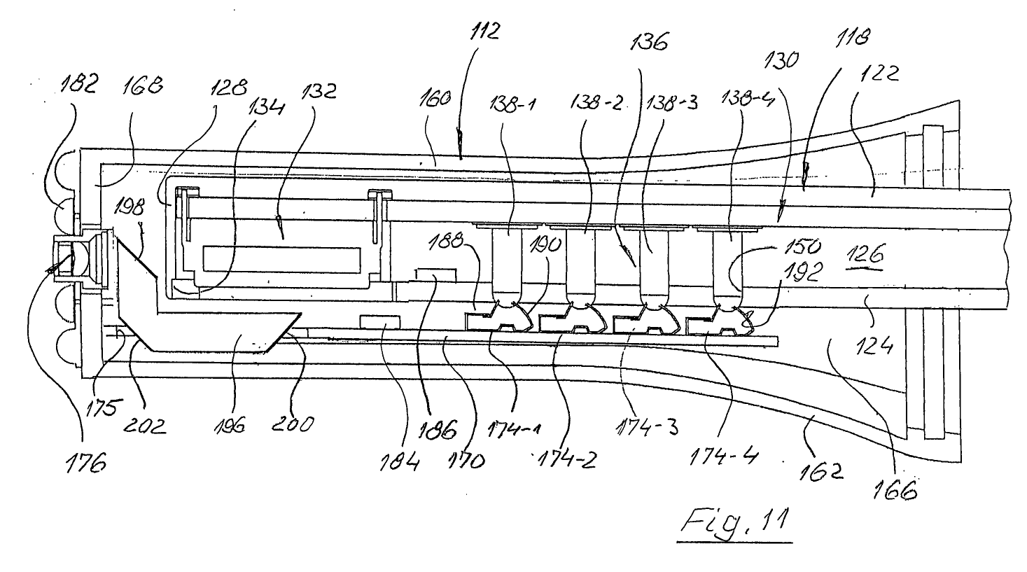

FIG. 10: a view similar to FIG. 9, wherein, however, an angled head member has been mounted onto the end of the handle member;

FIG. 11: a view similar to FIG. 10, wherein, however, instead of the angled head member a direct-vision head member has been mounted onto the handle member; and

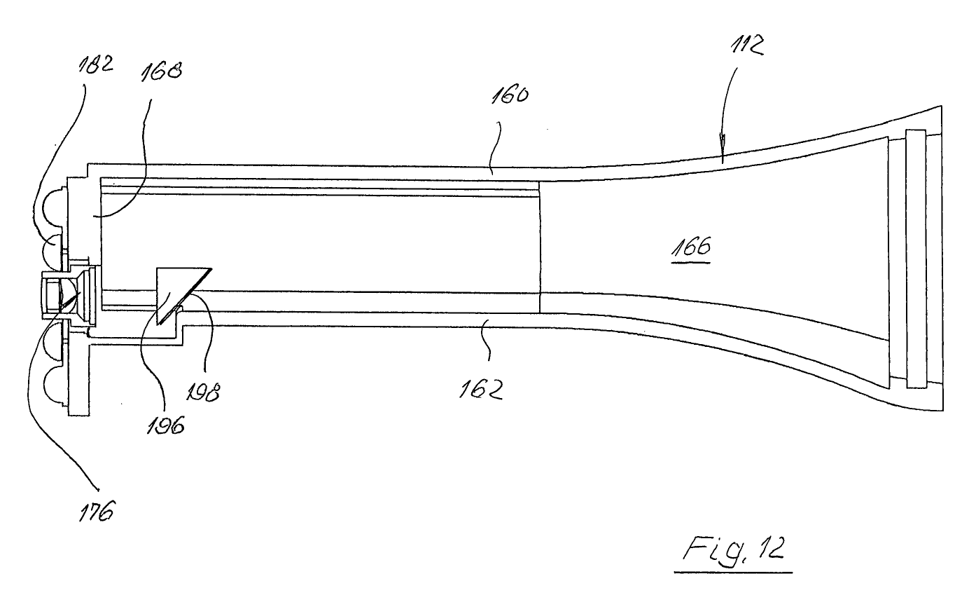

FIG. 12: a modified direct-vision head member in an axial sectional view.

FIG. 1 shows a handpiece camera which, for example, is capable of being used in the oral region or for the purpose of examining the skin.

The camera exhibits a housing 10 with a head member 12 and a handle member 14. In the head member 12 an entrance window 16 is arranged. In the head member 12 an annular light-source 18 is arranged which generates white light. The light-source 18 includes several light-emitting diodes arranged in distributed manner around the entrance window 16.

A first lens 20a is arranged in spaced manner behind the entrance window 16 in the head member 12. Firmly connected to the head member 12 is a redirecting prism 20b. For the purpose of avoiding damage, a protective cap 22 is arranged on the prism 20b.

In the handle member 14 further lenses 20c, 20d, 20e and a diaphragm 24 are arranged, and downstream of these components an image-converter 26 is located.

For the purpose of setting the sharpness of the image, a drive, shown schematically at 27, is provided for displacing the image-converter 26 in the direction of the optical axis 28 of the handle member 14.

The image-converter 26 is connected to camera electronics 30 which enable a setting of camera components of optical and electronic type and also a representation and suitable processing of a recorded image.

Arranged on the head member 12 is a transponder 32 which contains information about the structure of the head member 12. As soon as the head member 12 has been paired with a handle member 14 as drawn, a reading device 34 arranged in the handle member 14 reads out this information and transmits it to the camera electronics 30. On the basis of the transmitted information about the structure of the head member 12 the camera electronics 30 automatically perform various operational settings, for example a setting of the white balance, a setting of the voltage for the illumination unit 18, a setting of the diaphragm 24, a setting of an image-signal amplification and/or of a focusing.

On the side facing towards the handle member 14 the head member 12 exhibits a detent bead 36 which has been clicked under bias into a groove 38 provided in the handle member 14. Hence the head member 12 can be removed from the handle member 14 without any tool with slight application of force and can be replaced by another head member 12.

In the course of the examination of a test object, for example a tooth, the entrance window 16 is directed onto the place to be examined. Light emitted from the light-source 18 is incident on the test object. The white light emitted from the light-source is reflected from the test specimen as observation light. The observation light enters the camera via the entrance window 16 and is directed by the redirecting prism 20b onto the image-converter 26 via the lenses 20c, 20d, 20e and the diaphragm 24.

FIG. 2 shows a further head member 12 which is capable of being exchanged for the head member 12 in FIG. 1. For the sake of better readability, this variant of the head member 12 and also those of the further Figures are denoted by the same reference symbols, even though the structure thereof differs.

The entire elaborate optics and electronics of the handle member 14 shown in FIG. 1 are capable of being utilised with the head member 12 shown in FIG. 2 for further examinations. In contrast to the head member 12 in FIG. 1, the light-source 18 now comprises UV-light-emitting diodes. The UV light optically excites any bacteria carried by the test specimen, so that they emit fluorescent light of another colour as observation light. On the basis of fluorescent light that has its origin in bacteria, healthy and diseased tissue regions can be distinguished.

The entrance window 16 is constructed as a low-pass cut-off filter which completely absorbs the exciting UV light, so that only the fluorescent light impinges on the image-converter 26.

FIG. 3 shows a further direct-vision head member 12 which is capable of being combined with the handle member 14 from FIG. 1. This head member 12 conducts the observation light without redirection along the optical longitudinal axis 28 in the direction of the image-converter 26. The light-source 18 includes particularly powerful white-light-emitting diodes, suitable for extra-oral photographs, for example.

The three head members 12 shown in FIGS. 1 to 3 represent merely exemplary embodiments that are capable of being combined with the handle member 14 from FIG. 1. For example, head members 12 with further lenses for wide-angle photographs or macrophotographs and also with further or other filters are capable of being prepared. Furthermore, depending on the end use, differing light-sources 18 may have been arranged on the head members 12, for example infrared or laser light-sources, light-sources of differing or adjustable intensity, or pulsed light-sources.

A further field of use of the division of the camera into head member and handle member is opened up by means of adapters that enable a coupling to a microscope or an endoscope.

FIG. 4 shows a further embodiment of a camera with a head member 12 and a handle member 14. The arrangement of the optical elements 20b, 20d, 20e and 24 corresponds to the design described in FIG. 1.

The head member 12 includes a white-light-diode light-source 18 and an entrance window 16.

In the handle member 14 a permanent magnet 40a which is displaceable in the direction of the optical longitudinal axis 28 is arranged, the south pole pointing in the direction of the head member 12. The right-parallelipipedal magnet 40a is connected via a rod 42 to a spring 44 supported on the inside of the housing. Coupled to the rod 42 is a wedge 46a, the wedge surface of which may also have been designed in a modification as a control cam.

On the surface of the wedge 46a there runs a roller 46b which in the drawing has been upwardly biased by spring force and which actuates an adjusting mechanism of the diaphragm 24, which is not shown. The spring 44 holds the magnet 40a in a defined position, by virtue of which a defined stop-number has been set via the wedge element 46a and the roller 46b.

Two reed switches 48, 50 are spaced in relation to the magnet 40a, so that they are normally open. The reed switches 48, 50 are connected to the camera electronics 30 via wires which are not represented.

FIG. 5 shows the handle member 14 from FIG. 4 in combination with another head member 12.

Arranged in the head member 12 shown in FIG. 5 is a light-source 18 comprising highly luminous light-emitting diodes for photographs outside the oral cavity. In the head member 12, in contrast to the design in FIG. 1, a magnet 40b is arranged, the south pole of which is directed in the direction of the handle member 14. By reason of the repelling poles of magnet 40b and of magnet 40a, the latter is displaced against the force of the spring 44 in the direction of the longitudinal axis 28 away from the head member 12 when the head member 12 is being mounted onto the handle member 14. At the same time, the wedge element 46a is also displaced in the same direction, whereby the roller 46b biased by spring force runs upwardly on the wedge surface and hence opens the diaphragm 24 further.

By approach of the magnet 40a, the spacing from reed switch 50 decreases, so that the latter closes. The camera electronics 30 detect the closed contact 40a and set the white balance, amplification, etc. to values matched to the head member 12 shown in FIG. 5.

In FIG. 6 the handle member 14 from FIG. 5 is shown once again, which in addition to the structure of the head member 12 from FIG. 4 exhibits an optical lens 20a spaced from the entrance window 16, which, for example, is suitable for macrophotographs.

In the head member 12 a permanent magnet 40b is furthermore arranged, the north pole of which faces towards the handle member 14. The magnets 40b and 40a attract one another, by virtue of which magnet 40a is shifted in the direction of the head member 12. Together with magnet 40a the wedge 46a is shifted in turn, the roller 46b rolls along the wedge surface downwardly in the drawing and closes the diaphragm 24 further.

By reason of the enlargement of the spacing of magnet 40a from reed contact 50, the latter opens. The spacing of magnet 40a from reed contact 48 decreases, so that the latter closes. The camera electronics 30 evaluate the signals of the reed contacts 48, 50 as previously described and make appropriate settings.

In an alternative embodiment, not shown, on the basis of the evaluation of the position of the reed contacts 48, 50 the camera electronics 30 take over the adjustment of the diaphragm 24 by driving an electric drive unit.

The camera handpiece shown in FIGS. 7 ff. includes a housing 110, parts of which are a detachable head member 112 and also a handle member 114.

The handle member 114 has a base portion 116 exhibiting larger diameter and also a slender long columnar portion 118 carried by said base portion. The columnar portion 118 is arranged on a dished fastening portion 120 and has a first axially parallel main wall 122 situated at the top in Figure and also a parallel main wall 124 situated at the bottom in FIG. 7. The longitudinal edges thereof are connected to one another by side walls 126, only one of which is discernible in FIG. 7.

The front end of the columnar portion 118 situated on the left in FIG. 7 is closed by an end wall 128.

In the interior of the columnar portion 118 a main board 130 adjacent to the main wall 122 finds acceptance. Said main board carries at its free end a camera chip 132.

The input window thereof is freely accessible through a window 134 which is provided at the free end of the main wall 124.

In addition, the main board 130 carries two contact groups 136 with contacts 138-1, 138-2, 138-3, 138-4 which are situated one behind the other in pairs aligned perpendicular to the plane of the drawing. Each of the contacts 138 has a flange-shaped base portion 144, via which it is mechanically and electrically connected to a conductor track of the main board 130. The base portion 144 carries in each instance a peg portion 146, and the peg portions 146 each have a spherical end portion 148. The ends of the peg portions 146 and end portions 148 are located in openings 150 which are formed in the lower main wall 124 in such a manner that a part of the end portions 148 protrudes downwardly.

The main board 130 further carries, for instance at its centre, a motor 152 which drives an unbalanced mass 154. The motor 152 is energised when an actuation (for example for the recording of an image) occurs on a push-button switch fitted to the housing 110, as a result of which a tactile feedback relating to correct reception of the command is created.

At the end situated on the right in the Figures the main board 130 is connected via conductors 156 to a plug-in-connector member 158 via which a connection of the handpiece camera to an external operating and evaluating unit follows.

The head member 112 has, roughly speaking, such a shape that it surrounds the columnar portion 118 with slight clearance. It has an upper main wall 116, a lower main wall 162, side walls 166, only one of which again is visible in the drawing, and also an end wall 168. These walls together form, in a manner similar to the walls of the columnar portion 118, a right-parallelipipedal structure with generously rounded longitudinal edges and transverse edges.

The head member 112 carries in its interior a secondary board 170 which co-operates with the contact group 136 via two mating-contact groups 172 to be described in still more detail later.

The mating-contact groups 172 comprise mating contacts 174-1, 174-2, 174-3 and 174-2 which are situated one behind the other aligned in pairs, the spacing of which corresponds to the spacing of the contacts 138.

At its free end situated on the left in the drawing the secondary board 170 is provided with an opening 175 into which an objective 176 has been firmly inserted.

An objective mount is stepped on the outside and accepts there a sleeve-like hub portion 178 of a circular-disc-shaped window plate 180 which has been produced from plastic material that is transparent in the visible region and, where appropriate, in the UV region. The window plate 180 is not flat but in various subregions constitutes smooth continuations of the outer surface of the housing 110, so that the outer surface of the housing in the region of the window plate 180 is smoothly continuous overall.

The underside of the secondary board 170 carries, situated above the window plate 118, a ring of light-emitting diodes 182 which have been distributed evenly in the circumferential direction and which emit white light or blue or ultraviolet light downwardly. Two nested sets of LEDs distributed in the circumferential direction may also have been provided, one set of which makes white light available, the other blue light or ultraviolet light.

On the upper side of the secondary board 170 an IC 184 is discernible which contains an RFID or another transponder which contains data relating to the type of the head member 112 and, where appropriate, still further particulars relating to the head member 112 that are useful for the readout of the camera chip 132 and/or for the evaluation or processing of the image recorded by this chip. The IC 184 co-operates with a corresponding receiver chip 186 which is arranged on the main board 130, as evident from FIG. 10.

The contact springs 172 have been produced from a lamellar leaf-spring material that exhibits good electrical conduction. The contact springs 170 have, roughly speaking, the shape of a rectangle which has been broken open in the upper right portion and exhibits there two spring arms 188, 190. The spring arms 188, 190 have been configured at their free ends in the form of a circular arc, matching the curvature of the end portions 148.

The lower side of the rectangle exhibits a trapezoidal indentation 192, and the region of the lower side of the rectangle situated to the right of said indentation is convexly vaulted, as shown at 194. In the unloaded state spring arm 190 is likewise convexly curved in the form of a circular arc, as evident from the selective enlargement shown in FIG. 10.

The contacts 138 and also the contacts arranged parallel thereto behind the plane of the drawing constitute the contact group 136 which is fixed with respect to the housing, whereas the contact springs 174 constitute the movable mating-contact group 172. The contacts can serve both for exchanging information between electronic components on the secondary board 170 and electronic components on the main board 130, and for driving actuators or other electrical loads which are arranged on the secondary board, and for supplying power to loads arranged on the secondary board.

In this connection the contacts 138-1, which are closed last when the head member 112 is being fitted, are intended to transmit the supply voltage necessary for operating the components carried by the secondary board 170. The fitting of the head member 112 is consequently undertaken in stress-free manner until the contacts 138-1 come into engagement with the assigned mating contacts 174-1.

In the embodiment according to FIG. 11 a direct-vision head member 112 has been mounted onto the handle member 114. In this embodiment the axis of the lens arrangement 176 coincides with the axis of the handle member 114.

The feeding of the light guided back from the observation-point to the camera chip 132 is undertaken by an angled prism 196 made of transparent optical material, which at the two ends of its arms exhibits reflecting surfaces 198, 200 positioned at 45° and at the joint of the two arms bears a reflecting surface 202 likewise positioned at 45°. These mirrors may have been realised by a silvering being applied onto appropriately positioned and ground end faces of the prism 196, for example by vapour deposition.

A further difference exhibited by the head member 112 according to FIG. 11 from that according to FIG. 10 consists in that a ring of normal light-emitting diodes 182—which may be white-light diodes, UV diodes or blue-light diodes or a mixture of these diode types—has been provided around the objective.

In other respects, in FIG. 11 the same reference symbols have been used as in FIG. 10. The corresponding components do not need to be described again in detailed manner.

In FIG. 12 a further modified head member 112 is represented which is likewise a direct-vision head member. Here the axis of the lens arrangement 176 is located somewhat below the axis of the handle member 114, allowing the light reflected back from the site of examination to be guided onto the camera chip 132 by using a simple trihedral prism 196.

1. A handpiece camera comprising:
a housing,
a plurality of optical elements carried by the housing and
an image-converter arranged in the housing,
and wherein the housing includes a head member and a handle member detachably connected to said head member.

2. The handpiece camera according to claim 1, wherein an illuminating device is carried by the head member.

3. The handpiece camera according to claim 1, wherein at least one of the optical elements is arranged in the head member.

4. The handpiece camera according to claim 3, wherein the at least one optical element comprises a lens.

5. The handpiece camera according to claim 3, wherein the at least one optical element includes a filter.

6. The handpiece camera according to claim 5, wherein an entrance window of the head member is a filter.

7. The handpiece camera according to claim 3, wherein the at least one optical element is a redirecting device.

8. The handpiece camera according to claim 1, wherein a thermally conducting connection is provided between the head member and the handle member.

9. The handpiece camera according to one of claim 1, wherein the illuminating device is electrically operated.

10. The handpiece camera according to claim 9, wherein an electrical contact arrangement is provided between the head member and the handle member.

11. The handpiece camera according to claim 10, wherein the electrical contact arrangement exhibits at least one set of contacts situated one behind the other in the direction of insertion of the head member.

12. The handpiece camera according to claim 11, wherein contacts serving for supplying power to the head member are the contacts closed last when the head member is being fitted.

13. The handpiece camera according to claim 11, wherein the contact arrangement exhibits contacts with rounded end portions and exhibits mating contacts co-operating with said rounded end portions.

14. The handpiece camera according to claim 13, wherein the mating contacts each exhibit two leaf-spring arms which accept between themselves from two sides a contact.

15. The handpiece camera according to claim 14, wherein the free ends of the leaf-spring arms have free end edges which are configured in the form of a circular arc.

16. The handpiece camera according to claim 1, wherein the illuminating device emits UV light and/or white light and/or IR light.

17. The handpiece camera according to one of claim 1, wherein the illuminating device includes at least one LED.

18. The handpiece camera according to claim 1, wherein setting means are provided which, depending on a design of the head member arranged on the handle member, act on an optical element and/or on an electrical element.

19. The handpiece camera according to claim 18, wherein the setting means include a transponder and a transponder reader.

20. The handpiece camera according to claim 19, wherein the setting means include electrical contacts.

21. The handpiece camera according to claim 20, wherein the setting means include at least one magnet.

22. The handpiece camera according to claim 21, wherein in the handle member a first magnet is arranged which occupies differing positions in the case of a head member without magnet, in the case of a head member with a second magnet arranged in homopolar manner with respect to the first magnet, or in the case of a head member with a second magnet arranged in antipolar manner with respect to the first magnet.

23. The handpiece camera according to claim 21, wherein at least one reed switch arranged in the handle member interacts with a magnet arranged in the handle member or in the head member.

24. The handpiece camera according to claim 22, wherein a magnet in the handle member interacts with the actuating element of a diaphragm arranged upstream of the image-converter.

25. The handpiece camera according to claim 24, wherein the magnet in the handle member co-operates with the diaphragm via a mechanical connection.

26. The handpiece camera according to claim 18, wherein the setting means interact with an electric drive unit provided for adjusting an optical element.

27. The handpiece camera according to claim 18, wherein the setting means interact with camera electronics connected to the image-converter, which as a function of the design of the head member perform settings pertaining to said head member for image-recording and evaluation.

28. The handpiece camera according to one of claim 1, wherein the head member is connected to the handle member via an interlocking detent.
